(19) United States
(12) Patent Application Publication
(10) Pub. No.: US 2024/0082717 A1
(43) Pub. Date: Mar. 14, 2024

(54) RECORDING MEDIUM AND INFORMATION PROCESSING DEVICE

(71) Applicant: SEGA CORPORATION, Tokyo (JP)

(72) Inventors: Sho Suzuki, Tokyo (JP); Kosei Miyoshi, Tokyo (JP); Yuezong Chen, Tokyo (JP); Chiaki Annaka, Tokyo (JP); Shoichiro Fukuyama, Tokyo (JP)

(73) Assignee: SEGA CORPORATION, Tokyo (JP)

(21) Appl. No.: 18/510,955

(22) Filed: Nov. 16, 2023

Related U.S. Application Data
(63) Continuation of application No. PCT/JP22/20293, filed on May 13, 2022.

(30) Foreign Application Priority Data
May 17, 2021 (JP) 2021-082979
May 17, 2021 (JP) 2021-082980

(51) Int. Cl. A63F 13/533; A63F 13/44; A63F 13/63; A63F 13/92

(52) U.S. Cl. CPC A63F 13/533; A63F 13/44; A63F 13/63; A63F 13/92; A63F 2300/638

(57) ABSTRACT

A non-transitory computer readable recording medium stores instructions for an information processing device that includes a processor, a storage device, and a display device, the instructions causing the processor to execute: storing, in the storage device, one or more game types that have been registered as a favorite by a player; receiving, from a player via a terminal device, a display request to display a list screen showing the registered game types; and in response to the display request, preferentially displaying on the list screen in the display device, from among the registered game types, a game type that satisfies a specific condition related to an execution deadline indicating an end of the game type.

### BACKGROUND

### Technical Field

The present invention relates to a recording medium storing instructions and an information processing device.

### Description of Related Art

There are conventional games in which a player can register other players, content, game types (such as quests and lottery games), etc., as favorites.

In relation to this, Patent Document 1 discloses a technique in which a player registers another player as a favorite, which makes it easier to select characters used by this other player as accompanying members.

### PATENT LITERATURE

Patent Literature 1: Japanese Patent No. 2014-198168

In a gaming technology such as this, the player can register one or more types of content as a favorite. However, when a plurality of game types are registered as a favorite, for example, the registered game types can become so complicated that it takes time and effort to select a game type to be executed (played).

### SUMMARY

One or more embodiments of the present invention provide a technological improvement over such conventional gaming technologies discussed above. In particular, one or more embodiments of the present invention provide an information processing device and a recording medium storing instructions that preferentially display a specific information that satisfies a specific condition among registered information, and execute or cancel registration of the registered information under a predetermined condition, which makes it easier to select the specific information from among the registered information, and enables organizing the information and saving space in the storage device.

According to a first mode of the present invention, a non-transitory computer readable recording medium stores instructions for a computer (e.g., an information processing device), the instructions causing the computer to function as: a storage unit (i.e., a storage device) for storing one or more game types registered as a favorite by a player; a reception unit (i.e., a processor) for receiving from the player via a terminal device a display request to display a list screen showing the registered game types; and a control unit (i.e., the processor) for preferentially displaying on the list screen in a display device, in response to the display request, from among the registered game types, a game type that satisfies a specific condition related to an execution deadline indicating an end of that game type.

Also, in a second mode of the present invention, the specific condition is that the execution deadline for the game type has not yet arrived at a time of receiving the display request.

Also, in a third mode of the present invention, the specific condition is that a time period from a time of receiving the display request until the execution deadline of the game type is within a specific time period.

Also, in a fourth mode of the present invention, in a case where the execution deadline has arrived for a specific game type among the game types already registered as the favorite, the control unit proposes to cancel registration of the specific game type.

Also, in a fifth mode of the present invention, the reception unit receives from the player via the terminal device a registration request to register a new game type as a favorite, and, in response to the registration request, the control unit proposes to cancel the registration of the specific game type, and instead proposes to register the new game type as the favorite.

Also, in a sixth mode of the present invention, in a case where the execution deadline has arrived for a specific game type among the game types already registered as the favorite, the control unit automatically cancels the registration of the specific game type.

Also, the non-transitory computer readable recording medium according to a seventh mode of the present invention causes a computer to function as: a storage unit (i.e., the storage) for storing one or more game types registered as a favorite by a player; a reception unit (i.e., the processor) for receiving from the player via the terminal device a display request to display a list screen showing the registered game types; and a control unit (i.e., the processor) for preferentially displaying on the list screen in the display device, in response to the display request, from among the registered game types, a game type that satisfies a specific condition related to a number of game executions by the player, wherein the specific condition is that the number of game executions is at least a first specific number of times.

Also, the non-transitory computer readable recording medium according to an eighth mode of the present invention causes a computer to function as: a storage unit (i.e., the storage) for storing one or more game types registered as a favorite by a player; a reception unit (i.e., the processor) for receiving from the player via the terminal device a display request to display a list screen showing the registered game types; and a control unit (i.e., the processor) for preferentially displaying on the list screen in the display device, in response to the display request, from among the registered game types, a game type that satisfies a specific condition related to a number of game executions by the player, wherein the specific condition is that the number of game executions is less than a first specific number of times.

Also, the non-transitory computer readable recording medium according to a ninth mode of the present invention causes a computer to function as: a storage unit for storing one or more game types registered as a favorite by a player; a reception unit for receiving from the player via the terminal device a display request to display a list screen showing the registered game types; and a control unit for preferentially displaying on the list screen in the display device, in response to the display request, those game types from among the registered game types that satisfy a specific condition related to a number of game executions by the player, wherein the specific condition is that the number of game executions within a time period from a time of receiving the display request until a specific time period ago is at least a first specific number of times.

Also, in a tenth mode of the present invention, in a case where the number of game executions is less than a second specific number of times that is less than a first specific number of times for a specific game type among the game types already registered as the favorite, the control unit proposes to cancel registration of the specific game type.

Also, in an eleventh mode of the present invention, in a case where the number of game executions is equal to or larger than a second specific number of times that is larger than a first specific number of times for a specific game type among the game types already registered as the favorite, the control unit proposes to cancel registration of the specific game type.

Also, in a twelfth mode of the present invention, in a case where the number of game executions during the time period is less than a second specific number of times that is less than a first specific number of times for a specific game type among the game types already registered as the favorite, the control unit proposes to cancel registration of the specific game type.

Also, in a thirteenth mode of the present invention, the reception unit receives from the player via the terminal device a registration request to register a new game type as a favorite, and, in response to the registration request, the control unit proposes to cancel the registration of the specific game type.

Also, in a fourteenth mode of the present invention, in a case where a number of game types already registered as the favorite has reached a specific number, in response to the registration request, the control unit proposes to cancel the registration of the specific game type, and instead proposes to register the new game type as the favorite.

Also, in a fifteenth mode of the present invention, in a case where the number of game executions during the time period is less than a second specific number of times that is less than a first specific number of times for a specific game type among the game types already registered as the favorite, the control unit automatically cancels registration of the specific game type.

Also, in a sixteenth mode of the present invention, the reception unit receives from the player via the terminal device a registration request to register a new game type as a favorite, and, in response to the registration request, the control unit automatically cancels the registration of the specific game type, and instead registers the new game type as the favorite.

Also, in a seventeenth mode of the present invention, the reception unit receives from the player via the terminal device a registration request to register a new game type as a favorite, and in a case where the number of game types already registered as the favorite has reached a specific number, in response to the registration request, the control unit automatically cancels the registration of the specific game type, and instead registers the new game type as the favorite.

Also, the information processing device according to an eighteenth mode of the present invention comprises: a storage device; a display device; and a processor that: stores, in the storage device, one or more game types that have been registered as a favorite by a player; receives from the player via a terminal device a display request to display a list screen showing the registered game types; and preferentially displays on the list screen in the display device, in response to the display request, from among the registered game types, a game type that satisfies a specific condition related to an execution deadline indicating an end of the game type.

Also, the information processing device according to a nineteenth mode of the present invention comprises: a storage device; a display device; and a processor that: stores, in the storage device, one or more game types registered as a favorite by a player; receives from the player via a terminal device a display request to display a list screen showing the registered game types; and preferentially displays on the list screen in the display device, in response to the display request, from among the registered game types, a game type that satisfies a specific condition related to the number of game executions by the player, wherein the specific condition is that a number of executions by the player is at least a first specific number of times.

Also, the information processing device according to a twentieth mode of the present invention comprises: a storage device; a display device; and a processor that: stores, in the storage device, one or more game types registered as a favorite by a player; receives from the player via a terminal device a display request to display a list screen showing the registered game types; and preferentially displays on the list screen in the display device, in response to the display request, from among the registered game types, a game type that satisfies a specific condition related to the number of game executions by the player, wherein the specific condition is that the number of executions by the player is less than a first specific number of times.

Also, the information processing device according to a twenty-first mode of the present invention comprises: a storage device; a display device; and a processor that: stores, in the storage device, one or more game types registered as a favorite by a player; receives from the player via a terminal device a display request to display a list screen showing the registered game types; and preferentially displays on the list screen in the display device, in response to the display request, from among the registered game types, a game type that satisfies a specific condition related to the number of executions by the player, wherein the specific condition is that the number of game executions by the player within a time period from a time of receiving the display request until a specific time period ago is at least a first specific number of times.

Also, the information processing device according to a twenty-second mode of the present invention comprises: a storage device; a display device; and a processor that: stores, in the storage device, one or more game types registered as a favorite by a player; receives from the player via a terminal device a display request to display a list screen showing the registered game types; and preferentially displays on the list screen in the display device, in response to the display request, from among the registered game types, a game type that satisfies a specific condition related to the execution deadline of the game type.

With the above features, it becomes easier to select to select the specific information from among the registered information, and enables saving space in the storage device.

### BRIEF DESCRIPTION OF THE DRAWINGS

FIG. 1 is a block diagram showing an example of the overall configuration of a game system according to a first embodiment;

FIG. 2 is a diagram schematically showing an example of the hardware configuration of a server device;

FIG. 3 is a diagram showing an example of the hardware configuration of a smart phone, as the terminal device shown in FIG. 1;

FIG. 4 is a block diagram schematically showing an example of the functional units of a server device;

FIG. 5 is a flowchart showing an example of the flow of processing for executing a game type registered as a favorite in the game system according to the first embodiment;

FIG. 6 is a diagram showing an example of a favorites list screen according to the first embodiment;

FIG. 7 is a flowchart showing an example of the flow of processing in updating the game types registered as a favorite in the game system according to the first embodiment;

FIG. 8 is a diagram showing an example of a game type list screen according to the first embodiment;

FIG. 9 is a diagram showing an example of a proposal screen according to the first embodiment;

FIG. 10 is a flowchart showing an example of the flow of processing for executing a game type registered as a favorite in the game system according to a second embodiment;

FIG. 11 is a flowchart showing an example of the flow of processing for updating a game type registered as a favorite in the game system according to the second embodiment;

FIG. 12 is a flowchart showing an example of the flow of processing for executing a game type registered as a favorite in the game system according to a third embodiment; and

FIG. 13 is a flowchart showing an example of the flow of processing for updating a game type registered as a favorite in the game system according to the third embodiment.

### DETAILED DESCRIPTION OF EMBODIMENTS

A number of embodiments of the present invention will now be described with reference to the appended drawings. To facilitate understanding of the description, components and steps that are the same will be numbered the same as much as possible in the drawings, and redundant descriptions will be omitted.

### First Embodiment

A first embodiment will be described now.

Overall Configuration

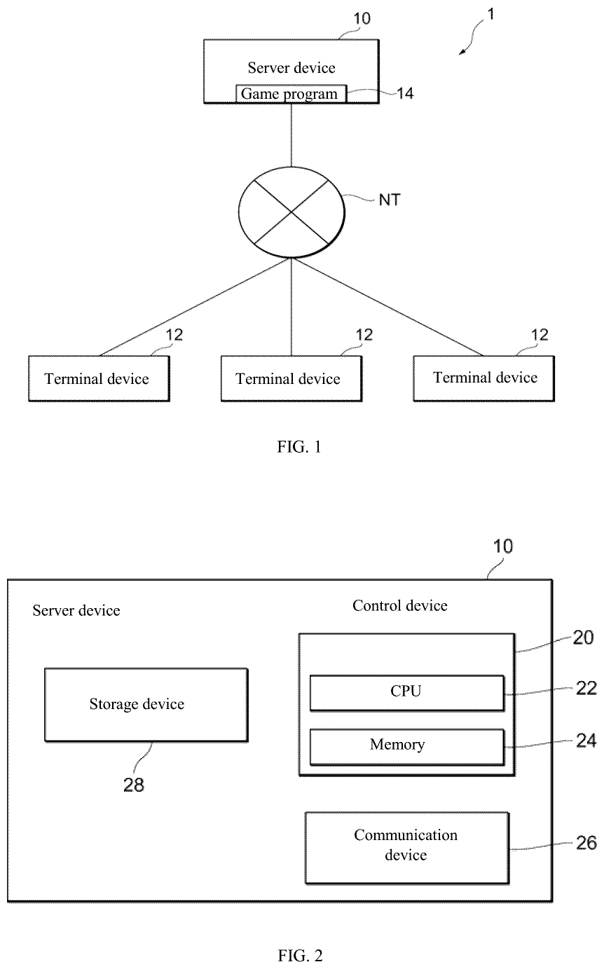

FIG. 1 is a block diagram showing an example of the overall configuration of a game system 1 according to a first embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing instructions such as the game program 14, or the instructions such as the game program 14 themselves, to the player of each terminal device 12 via the communication network NT. In the first embodiment, the server device 10 provides the game program 14 itself to the players of the terminal devices 12.

Each terminal device 12 is an information processing device belonging to a player, and is an information processing device that provides a game to a player by executing the game program 14 received from the server device 10 after the instructions have been installed. Examples of these terminal devices 12 include video game machines, arcade game machines, mobile phones, smartphones, tablets, personal computers, and various other such devices.

Hardware Configuration

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 (processor) and a memory 24 (an example of non-transitory computer readable recording medium).

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the game program 14, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for comprising an operating device, a display device, and a sound output device, for example.

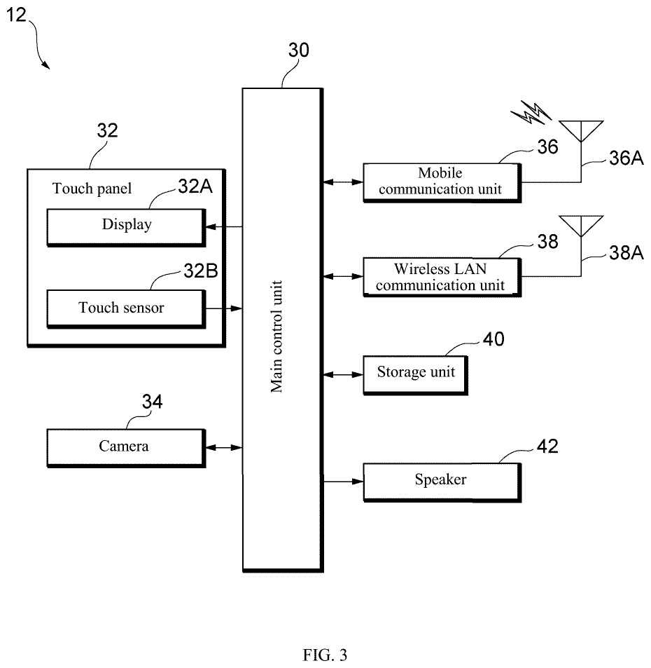

FIG. 3 is a diagram showing an example of the hardware configuration of a smartphone serving as the terminal device 12 shown in FIG. 1.

As shown in FIG. 3, the terminal device 12 comprises a main control unit 30, a touch panel (touch screen) 32, a camera 34, a mobile communication unit 36, a wireless LAN communication unit 38, a storage unit 40, and a speaker 42.

The main control unit 30 includes a CPU (processor), a memory (an example of non-transitory computer readable recording medium), and the like. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In the first embodiment, the display 32A can display game images including button images, a cross key image, a joystick image, and other such operation input images. The touch sensor 32B can sense the input position from the player with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the game program 14. This play data may be stored in the server device 10.

The speaker 42 has the function of outputting game sounds and so forth.

Game Summary

Games according to the first embodiment include lottery games and quests, which are game types in which a player can acquire characters as an example of content, rearing games in which characters possessed by a player are strengthened or evolved, or the like. These lottery games are sometimes referred to as gacha (loot box), raffles, summonings, or the like. These quests are sometimes referred to as battle games, dungeons, searches, missions, or the like.

A lottery game according to the first embodiment is a game in which a player is allowed to earn one or more randomly selected characters from the lottery target character group, in accordance with an instruction (request) from a player to execute a lottery game. This lottery is executed on the basis of consumption of currency items possessed by the player. Examples of these currency items include charged items (paid stones, paid tickets, etc.) and non-charged items (free stones, free tickets, etc.). A charged item is a paid item granted to the player on the basis of a payment made with money, a prepaid card, a credit card, or the like. Also, a non-charged item is a free item given to the player in the game. A non-charged item may have the same value as, for example, a charged item.

Also, a quest according to the first embodiment is a game in which a team composed of one or more characters possessed by a player and enemy characters play against each other on the basis of an instruction (request) from the player to execute the quest.

For example, in an organization menu for organizing characters to be used in the quest, the player can organize characters to be used in the quest by arbitrarily selecting one or more characters from their possessed characters.

These quests are executed on the basis of the consumption of the current stamina associated with the player. When the player clears the quest, that is, when the hit points of an enemy character (boss character) that appears at the end fall to zero or less, the player can acquire a clearance reward. Examples of clearance rewards include non-charged items (free stones, free tickets, etc.), coins, enemy characters that appear in quests, player experience points, and so on.

A rearing game according to the first embodiment is a game in which a resource character (resource content) is fused with a base character (base content). In this fusion, resource characters are lost from the player's possessed characters in exchange for the ability to rear base characters.

In a rearing game according to the first embodiment, strengthening fusion is performed as a first character fusion, by which the ability parameters of the base character are changed by consuming a certain number of coins and a resource character arbitrarily selected by the player.

For example, if the player arbitrarily selects a base character and a resource character from his possessed characters in the strengthening fusion menu in a rearing game, the player can perform strengthening fusion on the condition that the player possesses a certain number of coins.

For example, when a resource character of a different type from a base character possessed by a player undergoes strengthening fusion with that base character, the normal parameters (such as the level) of that base character increase. Also, for example, when a resource character of the same type as a base character possessed by a player undergoes strengthening fusion with that base character, the normal parameters and specific parameters (such as luck) of that base character increase. A specific parameter of a base character increases in accordance with the specific parameter of the resource character that is of the same type as that base character. More specifically, if the specific parameter of a resource character of the same type as the base character is 10, the specific parameter of the base character increases by 10 through strengthening fusion. The maximum value of this specific parameter may be 99, for example. Consequently, even if a player acquires a character of the same type as a possessed character in a game type (lottery game or quest), the specific parameters of that possessed character can still be changed (increased), which affords the player a certain level of satisfaction.

Also, with the rearing game according to the first embodiment, evolution fusion is performed as a second character fusion, by which a base character is evolved into an evolved character (evolved content), which is a different character, by consuming a cost associated with that base character in advance.

For example, when the player arbitrarily selects a base character from his possessed characters in an evolution fusion menu in the rearing game, the player can perform evolution fusion on the condition that the player possesses the cost associated with the base character (evolution resource characters, coins, etc.) in advance.

Functional Units

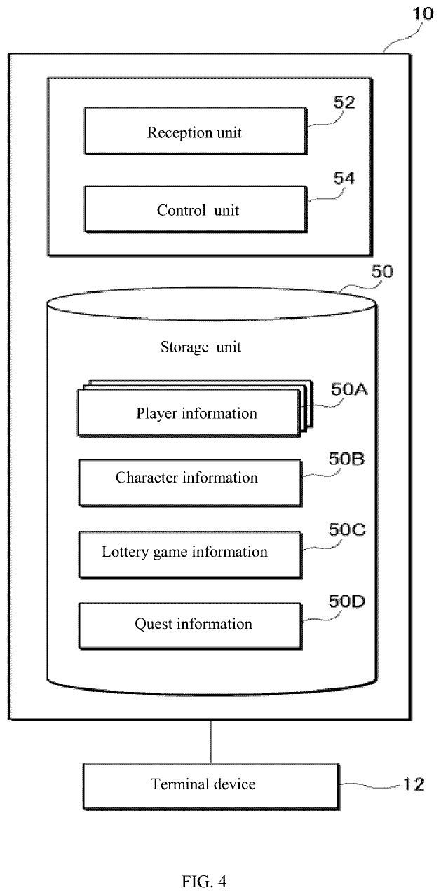

FIG. 4 is a block diagram schematically showing an example of the functional units of the server device 10.

As shown in FIG. 4, the server device 10 comprises, as functional components, a storage unit 50, a reception unit 52, and a control unit 54. The storage unit 50 is realized in the form of one or more storage devices 28. Functional units other than the storage unit 50 are realized when the control device 20 executes the game program 14 stored in the storage device 28 or the like.

The storage unit 50 has the function of storing player information 50A, character information 50B, lottery game information 50C, quest information 50D, and the like.

Player information 50A is stored for each player in association with the player ID of that player. This player information 50A may include, for example, the player's name, age, player rank, possessed content information, game type information, stamina information, and the like.

The player rank increases when the player acquires player experience points, for example.

Possessed content information includes possessed character information, possessed item information, possessed coin information, and the like. Possessed character information includes the character ID of each character possessed by the player, the ability parameters (level, specific parameters, hit points, attack power, defense power, etc.) of each character, and acquired characters. A possessed character is a character that the player can use in quests and rearing games. Acquired characters include the character IDs of characters that the player has acquired in the past, regardless of whether the player currently possesses the character.

Game type information includes one or more game types registered as a favorite by the player. This game type information may include, for example, a registration flag for each game type (lottery game or quest). This registration flag may include, for example, “1” when the game type is registered as a favorite, and may include “0” when not registered as a favorite. An upper limit may be set for the number of game types that the player can register as a favorite (such as 10 for lottery games and 50 for quests).

Possessed item information includes the item ID and number of each item possessed by the player. These items include paid stones, paid tickets, free stones, free tickets, stamina recovery items, and the like. Possessed coin information includes the number of coins possessed by the player.

Stamina information includes the player's current stamina value and stamina upper limit value. The current stamina value is a value consumed when the player executes various quests. This current stamina value increases by a specific amount (such as 1) after a certain period of time (such as 3 minutes) elapses, and recovers to the stamina upper limit value. Also, this current stamina value is recovered beyond the stamina upper limit value when the player consumes paid stones, free stones, stamina recovery items, and the like. This stamina upper limit value increases along with the player rank.

Character information 50B is stored for each character in association with the character ID of that character. The character information 50B may include, for example, the character name and image, ability parameter information, and rarity. This character information 50B is updated from time to time via a game update by the game operator.

Ability parameter information includes the initial values and maximum values for the various ability parameters of a character.

Rarity may be represented by a number from 1 to 6, for example. This number may be indicated by a number of stars, for example. Here, a character with a high rarity is set with an ability parameter or the like that is advantageous in a game (such as a quest).

Lottery game information 50C is stored for each lottery game in association with the lottery game ID of the lottery game. The lottery game information 50C includes the lottery game name and price, lottery target information, execution deadline, and the like.

Price includes the number of currency items consumed in order to execute the lottery game one time. For example, the price for a certain lottery game may be five items.

Lottery target information includes the character IDs of the characters constituting the lottery target character group of a lottery game, and the appearance frequency (weighting) associated with that character ID. Appearance frequency may be represented by a number from 1 to 10, for example. The appearance frequency is set to a low numerical value for a character with a high rarity, and to a high numerical value for a character with a low rarity. A character (with a rarity of 6, for example) that appears more frequently than other characters (pickup character) within the same rarity may be provided.

The execution deadline means the deadline by which a lottery game can be executed. An example of this deadline is the end date and time of an event lottery game. That is, if the execution deadline for a lottery game has passed, the player cannot execute that lottery game. The execution deadline for a lottery game that can be played any time may be indicated as #N/A.

Quest information 50D is stored for each quest in association with the quest ID of that quest. The quest information 50D includes the quest name, consumed stamina value, enemy character information, clearance reward information, execution deadline, and the like.

Consumed stamina value includes the value required to execute the quest. This consumed stamina value is deducted from the player's current stamina value, and the higher the difficulty of the quest, the higher the consumed stamina value is, for example.

Enemy character information includes character IDs and ability parameters of the enemy characters that appear in a quest. This enemy character includes a boss character that appears at the end of a quest.

Clearance reward information includes the number of unpaid items (such as free stones) and coins that can be earned when a quest is cleared, the character IDs and drop rates of enemy characters that can be earned, player experience points, and the like. The drop rate is the probability that the player will earn an enemy character, and the higher the difficulty of a quest, the higher this probability is.

The execution deadline includes the deadline by which a quest can be executed. An example of this deadline is the end date and time of an event quest. That is, if the execution deadline for a quest has passed, the player cannot execute that quest. The execution deadline for a quest (normal quest) that can be played any time may be indicated as #N/A.

The reception unit 52 is a functional unit for receiving operation instructions (requests) from the player. In the first embodiment, the reception unit 52 receives from the player a display request to display a list screen showing game types registered as a favorite. Examples of this display request include when a player presses a favorites button on a menu screen.

Also, in the first embodiment, the reception unit 52 receives from the player a registration request to register a new game type as a favorite. Examples of this registration request include when a player presses the registration button on a list screen showing one or more game types. Examples of this list screen include a screen showing a list of game types that the player has played recently, and a screen showing a list of each game type in the game type menu.

The control unit 54 is a functional unit for controlling the entire game. The control unit 54 preferentially displays a specific information that satisfies a specific condition among registered information in order to makes it easier to select the specific information from among the registered information. In the first embodiment, in response to a display request to display a list screen showing game types registered as a favorite, the control unit 54 preferentially displays on the list screen, from among the game types registered as a favorite, those game types that satisfy a specific condition related to the execution deadline of that game type. Examples of preferential display include displaying game types at the top of the list screen, displaying game types that do not satisfy the specific condition in a different display format, not displaying game types that do not satisfy the specific condition, and so on.

Also, in the first embodiment, the specific condition may be, for example, that the execution deadline for the game type has not yet arrived at the time when the display request is made. That is, in response to a display request, the control unit 54 preferentially displays on the list screen, from among the game types registered as a favorite, those game types whose execution deadline has not yet arrived.

Also, in the first embodiment, the specific condition may be, for example, that the period from the time when the display request is made until the execution deadline of the game type is within a specific timeframe (such as 24 hours). That is, in response to a display request, the control unit 54 preferentially displays on the list screen, from among the game types registered as a favorite, those game types for which the period from the time when the display request is made until the execution deadline of the game type is within a specific timeframe (such as 24 hours).

Also, in the first embodiment, the control unit 54 executes or cancels registration of the registered information under a predetermined condition, which enables organizing the information and saving space in the storage device. Specifically, the control unit 54 treats as a game type to be canceled, from among the game types already registered as a favorite, any game type whose execution deadline has arrived, and proposes the cancelation of the registration of that game type to be canceled. This proposal may be made at the time at which a registration request to register a new game type as a favorite is made, the time at which a player logs into the game, the time at which a display request to display a list screen showing game types registered as a favorite is made, and so on.

For example, the control unit 54 refers to the game type information in the player information 50A and the execution deadline in the lottery game information 50C, and treats as a lottery game to be canceled, from among the one or more lottery games already registered as a favorite by the player, any lottery game whose execution deadline has arrived, and proposes the cancelation of the registration of that lottery game to be canceled.

Also, for example, the control unit 54 refers to the game type information in the player information 50A and the execution deadline in the quest information 50D, and treats as a quest to be canceled, from among the one or more quests already registered as a favorite by the player, any quest whose execution deadline has arrived, and proposes the cancelation of the registration of that quest to be canceled.

Also, in the first embodiment, in response to a registration request to register a new game type as a favorite, the control unit 54 proposes the cancelation of the registration of a game type to be canceled, and proposes instead the registration of a new game type as a favorite.

For example, in response to a registration request to register a new lottery game as a favorite, the control unit 54 proposes the cancelation of the registration of a lottery game to be canceled, and proposes instead the registration of this new lottery game as a favorite.

Also, for example, in response to a registration request to register a new quest as a favorite, the control unit 54 proposes the cancelation of the registration of a quest to be canceled, and proposes instead the registration of this new quest as a favorite.

Also, in the first embodiment, if the number of game types already registered as a favorite has reached a specific number, in response to a registration request to register a new game type as a favorite, the control unit 54 proposes the cancelation of the registration of a game type to be canceled, and proposes instead the registration of a new game type as a favorite.

For example, the control unit 54 refers to the game type information in the player information 50A, and if the number of lottery games already registered as a favorite has reached a specific number (such as 5), in response to a registration request, the control unit 54 proposes the cancelation of the registration of a lottery game to be canceled, and proposes instead the registration of a new lottery game as a favorite. This specific number may be any number as long as it is no more than the upper limit number (such as 10) of lottery games that can be registered as a favorite by the player.

Also, for example, the control unit 54 refers to the game type information in the player information 50A, and if the number of quests already registered as a favorite has reached a specific number (such as 25), in response to a registration request, the control unit 54 proposes the cancelation of the registration of a quest to be canceled, and proposes instead the registration of a new quest as a favorite. This specific number may be any number as long as it is no more than the upper limit number (such as 50) of quests that can be registered as a favorite by the player.

Also, in the first embodiment, the control unit 54 treats as a game type to be canceled, from among the game types already registered as a favorite, any game type whose execution deadline has arrived, and automatically cancels the registration of that game type to be canceled. This cancelation may be performed at the time at which a registration request is made to register a new game type as a favorite, a specific time of day (such as at midnight every day), the time at which the player logs into the game, and so on.

For example, the control unit 54 refers to the game type information in the player information 50A and the execution deadline in the lottery game information 50C, and treats as a lottery game to be canceled, from among the one or more lottery games already registered as a favorite, any lottery game whose execution deadline has arrived, and automatically cancels the registration of that lottery game to be canceled.

Also, for example, the control unit 54 refers to the game type information in the player information 50A and the execution deadline in the quest information 50D, treats as a quest to be canceled, from among the one or more quests already registered as a favorite, any quest whose execution deadline has arrived, and automatically cancels the registration of that quest to be canceled.

Also, in the first embodiment, in response to a registration request to register a new game type as a favorite, the control unit 54 automatically cancels the registration of a game type to be canceled, and instead registers the new game type as a favorite.

For example, in response to a registration request to register a new lottery game as a favorite, the control unit 54 automatically cancels the registration of a lottery game to be canceled, and instead registers this new lottery game as a favorite.

Also, for example, in response to a registration request to register a new quest as a favorite, the control unit 54 automatically cancels the registration of a quest to be canceled, and instead registers this new quest as a favorite.

Also, in the first embodiment, if the number of game types already registered as a favorite has reached a specific number, in response to a registration request to register a new game type as a favorite, the control unit 54 automatically cancels the registration of a game type to be canceled, and instead registers a new game type as a favorite.

For example, the control unit 54 refers to the game type information in the player information 50A, and if the number of lottery games already registered as a favorite has reached a specific number (such as 10), in response to a registration request, the control unit 54 automatically cancels the registration of a lottery game to be canceled, and instead registers a new lottery game as a favorite.

Also, for example, the control unit 54 refers to the game type information in the player information 50A, and if the number of quests already registered as a favorite has reached a specific number (such as 50), in response to a registration request, the control unit 54 automatically cancels the registration of a quest to be canceled, and instead registers a new quest as a favorite.

Processing for Executing Favorite Game Type

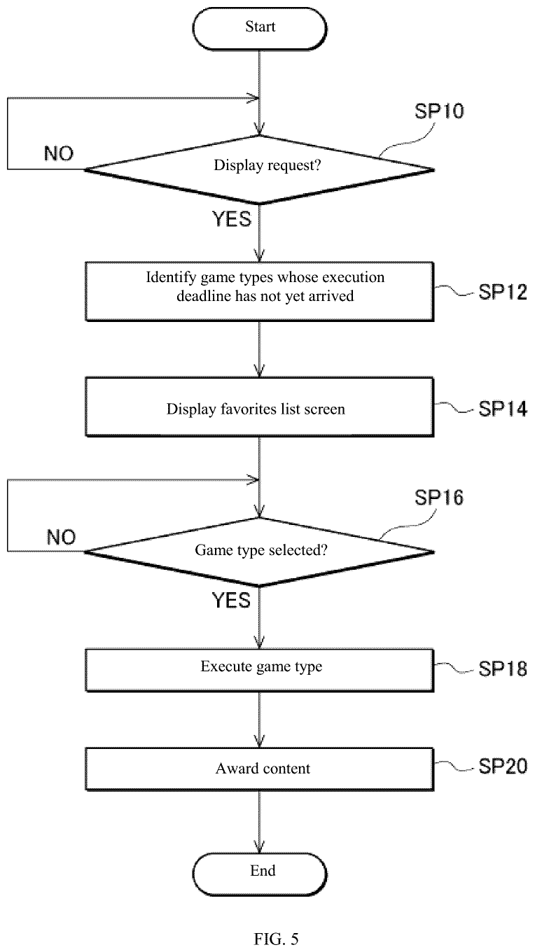

FIG. 5 is a flowchart showing an example of the flow of processing for executing a game type registered as a favorite in the game system according to the first embodiment. Also, the processing of the following steps is commenced at the time when the menu screen is displayed, for example. The order and details of the following steps can be changed as needed.

(Step SP10)

The reception unit 52 determines whether or not the player has pressed the favorites button on the menu screen. Then, if this determination is positive, the processing moves to the processing of step SP12. On the other hand, if the determination is negative, the processing moves to the processing of step SP10.

(Step SP12)

The control unit 54 refers to the game type information in the player information 50A and extracts game types registered as a favorite. Next, the control unit 54 refers to the execution deadline in the lottery game information 50C and the execution deadline in the quest information 50D, and identifies the extracted game types whose execution deadline has not yet arrived. Then, the processing moves to the processing of step SP14.

(Step SP14)

The control unit 54 causes the touch panel 32 to display a favorites list screen.

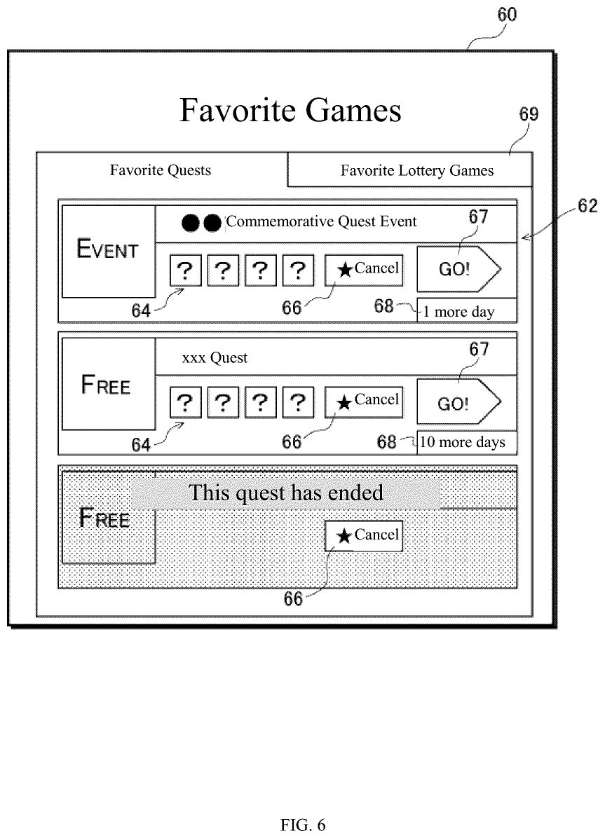

FIG. 6 is a diagram showing an example of the favorites list screen 60 according to the first embodiment.

As shown in FIG. 6, the favorites list screen 60 is provided with a game type information area 62, an acquirable content information area 64, a cancel button 66, an execute button 67, an execution deadline information area 68, and a display switching button 69. The game type information area 62 shows game types registered as a favorite by the player. In this game type information area 62, any game types identified in step SP12 are displayed preferentially (at the top). The acquirable content information area 64 shows some or all of the content (such as characters) that can be acquired in the associated game types. In the acquirable content information area 64, for example, a question mark is displayed for any content that the player has never acquired. The cancel button 66 is used to issue an instruction to cancel the favorite registration for the associated game type. This cancel button 66 is also displayed in association with any game types whose execution deadline has arrived. The execute button 67 is used to issue an instruction to execute the associated game type. For example, when the execute button 67 is pressed, a transition is made to an execution screen for the associated game type. The execution deadline information area 68 shows the execution deadline of the associated game type. The display switching button 69 is used to issue an instruction to switch the kind of game type (quest or lottery game) registered as a favorite.

Going back to FIG. 5, the processing moves to the processing of step S16.

(Step SP16)

The reception unit 52 determines whether or not the execute button has been pressed on the favorites list screen. If the determination is positive, the processing then moves to the processing of step SP18. On the other hand, if the determination is negative, the processing moves to the processing of step SP16.

(Step SP18)

The control unit 54 causes the touch panel 32 to display an execution screen for the game type whose execute button was pressed in step SP16, and executes that game type in response to an instruction from the player. Then, the processing moves to the processing of step SP20.

(Step SP20)

The control unit 54 provides content to the player in response to the execution of the game type. For example, when a quest is executed and that quest is cleared, the control unit 54 provides a clearance reward to the player. Also, when a lottery game is executed, for example, the control unit 54 awards one or more characters selected by lottery to the player. Then, the processing ends the processing series shown in FIG. 5.

Processing for Updating Favorite Game Types

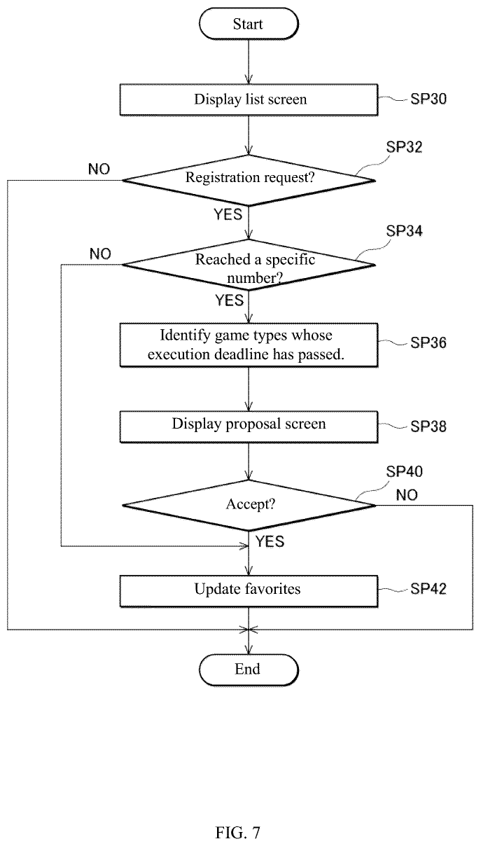

FIG. 7 is a flowchart showing an example of the flow of processing in updating the game types registered as a favorite in the game system according to the first embodiment. Also, the processing in the following steps is commenced, for example, at the time when an instruction to display a list of game types recently played by the player has been issued. The order and details of the following steps can be changed as needed.

(Step SP30)

The control unit 54 causes the touch panel 32 to display a list screen showing game types recently played by the player.

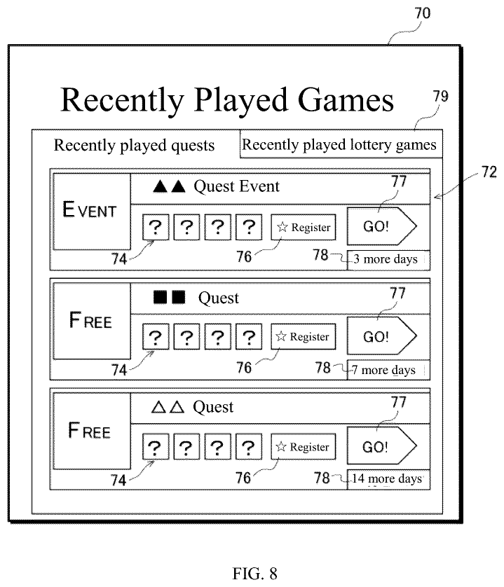

FIG. 8 is a diagram showing an example of the game type list screen 70 according to the first embodiment.

As shown in FIG. 8, the game type list screen 70 is provided with a game type information area 72, an acquirable content information area 74, a registration button 76, an execute button 77, an execution deadline information area 78, and a display switching button 79. The game type information area 72 shows the game types recently played by the player. The acquirable content information area 74 shows some or all of the content (such as characters) that can be acquired in the associated game type. The registration button 76 is used to issue an instruction to register the associated game type as a favorite. The execute button 77 is used to issue an instruction to execute the associated game type. The execution deadline information area 78 shows the execution deadline of the associated game type. The display switching button 79 is used to issue an instruction to switch the kind of game type (quest or lottery game) that the player has recently played.

Going back to FIG. 7, the processing moves to the processing of step SP32.

(Step SP32)

The reception unit 52 determines whether or not the player has pressed the registration button associated with one game type (new game type) on the game type list screen. For example, if the execute button has been pressed, the reception unit 52 makes a positive determination. If the determination is positive, the processing then moves to the processing of step SP34. On the other hand, if the determination is negative, the processing ends the processing series shown in FIG. 7.

(Step SP34)

The control unit 54 refers to the game type information in the player information 50A and determines whether or not the number of game types (such as quests) registered as a favorite has reached a specific number (such as 25). If the determination is positive, the processing then moves to the processing of step SP36. On the other hand, if the determination is negative, the processing moves to the processing of step SP42.

(Step SP36)

The control unit 54 refers to the game type information in the player information 50A and extracts game types registered as a favorite. Next, the control unit 54 refers to the execution deadline in the lottery game information 50C and the execution deadline in the quest information 50D, and identifies, as game types to be canceled, one or more of the extracted game types whose execution deadline has arrived. Then, the processing moves to the processing of step SP38.

(Step SP38)

The control unit 54 causes the touch panel 32 to display a proposal screen.

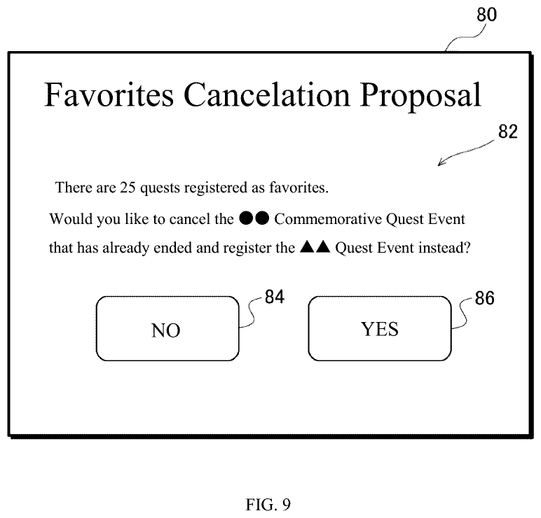

FIG. 9 is a diagram showing an example of a proposal screen 80 according to the first embodiment.

As shown in FIG. 9, the proposal screen 80 is provided with a proposal information area 82, a reject button 84, and an accept button 86. The proposal information area 82 shows that the number of game types (such as quests) registered as a favorite has reached a specific number (such as 25). Also, in the proposal information area 82 it is proposed that the favorite registration of the game type to be canceled identified in step SP36 be canceled, and instead, that the one game type (a new game type) for which the registration button was pressed in step SP32 be registered as a favorite. The reject button 84 is used to issue an instruction to reject the proposal. The accept button 86 is used to issue an instruction to accept the proposal.

Going back to FIG. 7, the processing moves to the processing of step SP40.

(Step SP40)

The reception unit 52 determines whether or not the accept button has been pressed by the player on the proposal screen. If the determination is positive, the processing then moves to the processing of step SP42. On the other hand, if the determination is negative, the processing ends the processing series shown in FIG. 7.

(Step SP42)

The control unit 54 registers as a favorite the new game type for which the registration button was pressed in step SP32. Also, if the accept button was pressed in step SP40, the control unit 54 cancels the favorite registration of the game type to be canceled that was identified in step SP36. Then, the processing ends the processing series shown in FIG. 7.

As described above, in the first embodiment, a computer is made to function as: the storage unit 50 for storing one or more game types registered as a favorite by the player; the reception unit 52 for receiving from the player a display request to display a list screen showing the registered game types; and the control unit 54 for preferentially displaying on the list screen, in response to the display request, those game types from among the registered game types that satisfy a specific condition related to an execution deadline of that game type.

With this configuration, game types that satisfy the specific condition related to the execution deadline are displayed preferentially on the list screen, which makes it easier to select game types that are registered as a favorite.

Also, in the first embodiment, the specific condition may be that the execution deadline for the game type has not yet arrived at the time when the display request is made.

With this configuration, game types whose execution deadline has not yet arrived are displayed preferentially on the list screen, which makes it easier to select game types that are registered as a favorite.

Also, in the first embodiment, the specific condition may be that the period from the time when the display request is made until the execution deadline of the game type is within a specific timeframe.

With this configuration, game types whose execution deadline is short are displayed preferentially on the list screen, which motivates the player to play those game types.

Also, in the first embodiment, the control unit 54 treats as a game type to be canceled, from among the game types already registered as a favorite, any game type whose execution deadline has arrived, and proposes the cancelation of the registration of that game type to be canceled.

With this configuration, those game types whose execution deadline has arrived are treated as ones to be canceled, and their registration can be easily canceled, so the number of game types registered as a favorite can be controlled.

Also, in the first embodiment, the reception unit 52 receives from the player a registration request to register a new game type as a favorite, and, in response to the registration request, the control unit 54 proposes the cancelation of the registration of a game type to be canceled, and proposes instead the registration of the new game type as a favorite.

With this configuration, when registering a new game type, the registration of a game type to be canceled can be easily canceled, so the number of game types registered as a favorite can be controlled.

Also, in the first embodiment, if the number of game types already registered as a favorite has reached a specific number, in response to a registration request, the control unit 54 proposes the cancelation of the registration of a game type to be canceled, and proposes instead the registration of the new game type as a favorite.

With this configuration, if the number of registered game types has reached a specific number, the registration of a game type to be canceled can be easily canceled, and a new game type can be registered instead, so the number of game types registered as a favorite can be controlled.

Also, in the first embodiment, the control unit 54 treats as a game type to be canceled, from among the game types already registered as a favorite, any game type whose execution deadline has arrived, and automatically cancels the registration of that game type to be canceled.

With this configuration, those game types whose execution deadline has arrived are treated as ones to be canceled, and their registration can be automatically canceled, so the number of game types registered as a favorite can be controlled.

Also, in the first embodiment, the reception unit 52 receives from the player a registration request to register a new game type as a favorite, and, in response to the registration request, the control unit 54 automatically cancels the registration of a game type to be canceled, and instead registers the new game type as a favorite.

With this configuration, when registering a new game type, the registration of a game type to be canceled can be automatically canceled, so the number of game types registered as a favorite can be controlled.

Also, in the first embodiment, if the number of game types already registered as a favorite has reached a specific number, in response to the registration request, the control unit 54 automatically cancels the registration of a game type to be canceled, and instead registers the new game type as a favorite.

With this configuration, if the number of registered game types has reached a specific number, the registration of a game type to be canceled can be automatically canceled, and a new game type can be registered instead, so the number of game types registered as a favorite can be controlled.

### Second Embodiment

A second embodiment will be described now.

The second embodiment differs from the first embodiment in that a game type that satisfies a specific condition related to the number of executions by the player is displayed preferentially on the list screen. The configuration and functions of the game system according to the second embodiment are the same as the configuration and functions of the game system according to the first embodiment, and will not be described below.

In the second embodiment, the game type information in the player information 50A includes, for each game type (lottery game or quest), the execution date and time when the player executed that game type and the number of times that the player has executed that game type.

In the second embodiment, in response to a display request to display a list screen showing game types registered as a favorite, the control unit 54 preferentially displays on the list screen, from among the registered game types, those game types that satisfy a specific condition related to the number of executions by the player.

Also, in the second embodiment, the specific condition may be, for example, that the number of executions by the player is at least a first specific number of times (such as 10). That is, in response to a display request, the control unit 54 preferentially displays on the list screen, from among the game types registered as a favorite, those game types for which the number of executions by the player is at least a first specific number of times.

Also, in the second embodiment, the specific condition may be that the number of executions by the player is less than a first specific number of times (such as 10). That is, in response to a display request, the control unit 54 preferentially displays on the list screen, from among the game types registered as a favorite, those game types for which the number of executions by the player is less than a first specific number of times.

Also, in the second embodiment, the specific condition may be that the number of executions by the player within a certain period of time (such as one week) since the display request was made is at least a first specific number of times (such as 10). That is, in response to a display request, the control unit 54 preferentially displays on a list screen those game types for which the number of executions by the player within a certain period of time since the display request was made is at least a first specific number of times.

Also, in the second embodiment, the control unit 54 treats as a game type to be canceled, from among the game types already registered as a favorite, any game type for which the number of executions by the player is less than a second specific number of times (such as 5) that is less than the first specific number of times (such as 10), and proposes the cancelation of the registration of that game type to be canceled.

For example, the control unit 54 refers to the game type information in the player information 50A, and treats as a lottery game to be canceled, from among the one or more lottery games already registered as a favorite by the player, any lottery game for which the number of executions is less than a second specific number of times, and proposes the cancelation of the registration of that lottery game to be canceled.

Also, for example, the control unit 54 refers to the game type information in the player information 50A, and treats as a quest to be canceled, from among the one or more quests already registered as a favorite by the player, any quest for which the number of executions is less than a second specific number of times, and proposes the cancelation of the registration of that quest to be canceled.

Also, in the second embodiment, the control unit 54 treats as a game type to be canceled, from among the game types already registered as a favorite, any game type for which the number of executions by the player is at least a second specific number of times (such as 15) that is greater than the first specific number of times (such as 10), and proposes the cancelation of the registration of that game type to be canceled.

For example, the control unit 54 refers to the game type information in the player information 50A, and treats as a lottery game to be canceled, from among the one or more lottery games already registered as a favorite by the player, any lottery game for which the number of executions is at least a second specific number of times, and proposes the cancelation of the registration of that lottery game to be canceled.

Also, for example, the control unit 54 refers to the game type information in the player information 50A, and treats as a quest to be canceled, from among the one or more quests already registered as a favorite by the player, any quest for which the number of executions is at least a second specific number of times, and proposes the cancelation of the registration of that quest to be canceled.

Also, in the second embodiment, the control unit 54 treats as a game type to be canceled, from among the game types already registered as a favorite, any game type for which the number of executions by the player within a certain period of time (such as one week) since the display request was made is less than a second specific number of times (such as 5) that is less than the first specific number of times (such as 10), and proposes the cancelation of the registration of that game type to be canceled.

For example, the control unit 54 refers to the game type information in the player information 50A, and treats as a lottery game to be canceled, from among the one or more lottery games already registered as a favorite by the player, any lottery game for which the number of executions within the period of time is less than a second specific number of times, and proposes the cancelation of the registration of that lottery game to be canceled.

Also, for example, the control unit 54 refers to the game type information in the player information 50A, and treats as a quest to be canceled, from among the one or more quests already registered as a favorite by the player, any quest for which the number of executions within the period of time is less than a second specific number of times, and proposes the cancelation of the registration of that quest to be canceled.

Also, in the second embodiment, the control unit 54 treats as a game type to be canceled, from among the game types already registered as a favorite, any game type for which the number of executions by the player within a certain period of time (such as one week) since the display request was made is less than a second specific number of times (such as 5) that is less than the first specific number of times (such as 10), and automatically cancels the registration of that game type to be canceled.

For example, the control unit 54 refers to the game type information in the player information 50A, and treats as a lottery game to be canceled, from among the one or more lottery games already registered as a favorite by the player, any lottery game for which the number of executions within the period of time is less than a second specific number of times, and automatically cancels the registration of that lottery game to be canceled.

Also, for example, the control unit 54 refers to the game type information in the player information 50A, and treats as a quest to be canceled, from among the one or more quests already registered as a favorite by the player, any quest for which the number of executions within the period of time is less than a second specific number of times, and automatically cancels the registration of that quest to be canceled.

Processing for Executing Favorite Game Type

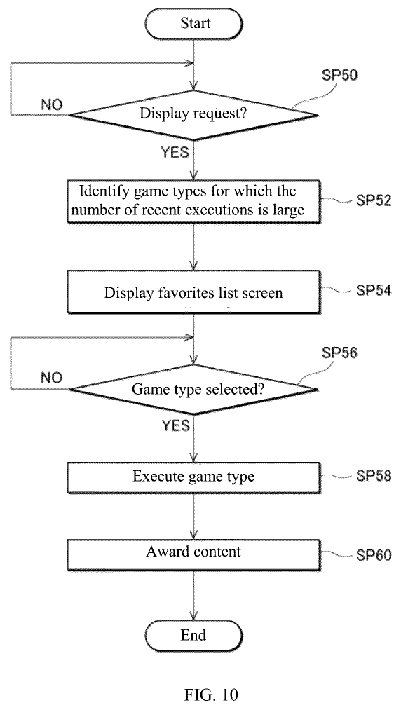

FIG. 10 is a flowchart showing an example of the flow of processing for executing a game type registered as a favorite in the game system according to the second embodiment. Also, the processing in the following steps is commenced at the time when the menu screen is displayed, for example. The order and details of the following steps can be changed as needed.

(Step SP50)

The reception unit 52 determines whether or not the player has pressed the favorites button on the menu screen. Then, if the determination is positive, the processing then moves to the processing of step SP52. On the other hand, if the determination is negative, the processing moves to the processing of step SP50.

(Step SP52)

The control unit 54 refers to the game type information in the player information 50A and extracts game types registered as a favorite. Next, the control unit 54 refers to the game type information in the player information 50A, and identifies, from among the game types registered as a favorite, those game types for which the number of executions by the player within a certain period of time (such as one week) since the display request was made is at least a first specific number of times (such as 10). Then, the processing moves to the processing of step SP54.

(Steps SP54 to SP60)

The processing from step SP54 to step SP60 is the same as the processing from step SP14 to step SP20 described above, and therefore will not be described again. Then, the processing ends the processing series shown in FIG. 10.

Processing for Updating Favorite Game Types

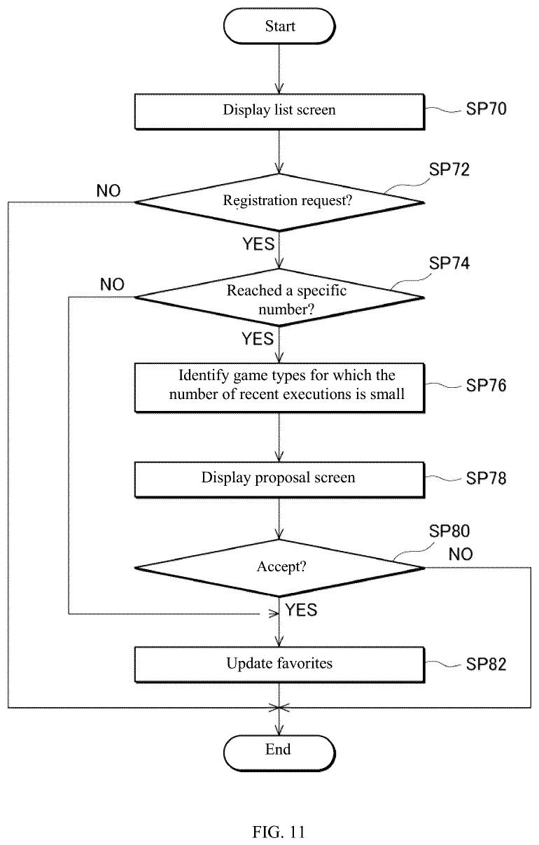

FIG. 11 is a flowchart showing an example of the flow of processing in updating the game types registered as a favorite in the game system according to the second embodiment. Also, the processing in the following steps is commenced, for example, at the time when an instruction to display a list of game types recently played by the player has been issued. The order and details of the following steps can be changed as needed.

(Steps SP70 to SP74)

The processing from step SP70 to step SP74 is the same as the processing from step SP30 to step SP34 described above, and therefore will not be described again. If the determination in step SP74 is positive, the processing moves to the processing of step SP76. On the other hand, if the determination is negative, the processing moves to the processing of step SP82.

(Step SP76)

The control unit 54 refers to the game type information in the player information 50A and extracts game types registered as a favorite. Next, the control unit 54 refers to the game type information in the player information 50A, and identifies, from among the game types registered as a favorite, those game types for which the number of executions by the player within a certain period of time (such as one week) since the display request was made is less than a second specific number of times (such as 5), which is less than the first specific number of times (such as 10). Then, the processing moves to the processing of step SP78.

(Steps SP78 to SP82)

The processing from step SP78 to step SP82 is the same as the processing from step SP38 to step SP42 described above, and therefore will not be described again. Then, the processing ends the processing series shown in FIG. 11.

Effect

As described above, in the second embodiment, a computer is made to function as: the storage unit 50 for storing one or more game types registered as a favorite by the player; the reception unit 52 for receiving from the player a display request to display a list screen showing the registered game types; and the control unit 54 for preferentially displaying on the list screen, in response to the display request, those game types from among the registered game types that satisfy a specific condition related to the number of executions by the player.

With this configuration, game types that satisfy the specific condition related to the number of executions by the player are preferentially displayed on the list screen, which makes it easier to select game types that are registered as a favorite.

Also, in the second embodiment, the specific condition may be that the number of executions by the player is at least a first specific number of times.

With this configuration, game types that have been played many times by the player are displayed preferentially on the list screen, which makes it easier to select game types that are registered as a favorite.

Also, in the second embodiment, the specific condition may be that the number of executions by the player is less than a first specific number of times.

With this configuration, game types that have been played only a few times by the player are displayed preferentially on the list screen, which motivates the player to play those game types.

Also, in the second embodiment, the specific condition may be that the number of executions by the player within a certain period of time since the display request was made is at least a first specific number of times.

With this configuration, game types that have been played many times recently by the player are displayed preferentially on the list screen, which makes it easier to select game types that are registered as a favorite.

In the second embodiment, the control unit 54 treats as a game type to be canceled, from among the game types already registered as a favorite, any game type for which the number of executions by the player is less than a second specific number of times that is less than the first specific number of times, and proposes the cancelation of the registration of that game type to be canceled.

With this configuration, those game types that have been played only a few times by the player are treated as ones to be canceled, and their registration can be easily canceled, so the number of game types registered as a favorite can be controlled.

Also, in the second embodiment, the control unit 54 treats as a game type to be canceled, from among the game types already registered as a favorite, any game type for which the number of executions by the player is at least a second specific number of times that is greater than the first specific number of times, and proposes the cancelation of the registration of that game type to be canceled.

With this configuration, those game types that have been played many times by the player are treated as ones to be canceled, and their registration can be easily canceled, so the number of game types registered as a favorite can be controlled.

Also, in the second embodiment, the control unit 54 treats as a game type to be canceled, from among the game types already registered as a favorite, any game type for which the number of executions by the player within a certain period of time is less than a second specific number of times that is less than the first specific number of times, and proposes the cancelation of the registration of that game type to be canceled.

With this configuration, those game types that have been played only a few times recently by the player are treated as ones to be canceled, and their registration can be easily canceled, so the number of game types registered as a favorite can be controlled.

Also, in the second embodiment, the reception unit 52 receives from the player a registration request to register a new game type as a favorite, and, in response to the registration request, the control unit 54 proposes the cancelation of the registration of the game type to be canceled.

With this configuration, when registering a new game type, the registration of a game type to be canceled can be easily canceled, so the number of game types registered as a favorite can be controlled.

Also, in the second embodiment, if the number of game types already registered as a favorite has reached a specific number, in response to the registration request, the control unit 54 proposes the cancelation of the registration of a game type to be canceled, and proposes instead the registration of the new game type as a favorite.

With this configuration, if the number of registered game types has reached a specific number, the registration of a game type to be canceled can be easily canceled, and a new game type can be registered instead, so the number of game types registered as a favorite can be controlled.

Also, in the second embodiment, the control unit 54 treats as a game type to be canceled, from among the game types already registered as a favorite, any game type for which the number of executions by the player within a certain period of time is less than a second specific number of times that is less than the first specific number of times, and automatically cancels the registration of that game type to be canceled.

With this configuration, those game types that have been played only a few times recently by the player are treated as ones to be canceled, and their registration can be automatically canceled, so the number of game types registered as a favorite can be controlled.

Also, in the second embodiment, the reception unit 52 receives from the player a registration request to register a new game type as a favorite, and, in response to the registration request, the control unit 54 automatically cancels the registration of a game type to be canceled, and instead registers the new game type as a favorite.

With this configuration, when registering a new game type, the registration of a game type to be canceled can be automatically canceled, so the number of game types registered as a favorite can be controlled.

Also, in the second embodiment, if the number of game types already registered as a favorite has reached a specific number, in response to the registration request, the control unit 54 automatically cancels the registration of a game type to be canceled, and instead registers the new game type as a favorite.

With this configuration, if the number of registered game types has reached a specific number, the registration of a game type to be canceled can be automatically canceled, and a new game type can be registered instead, so the number of game types registered as a favorite can be controlled.

### Third Embodiment

A third embodiment will be described now.

The third embodiment differs from the first embodiment in that game types that satisfy a specific condition related to content not possessed by the player are displayed preferentially on the list screen. The configuration and functions of the game system according to the third embodiment are the same as the configuration and functions of the game system according to the first embodiment, and will not be described below.

In the third embodiment, the lottery game information 50C includes identification information that identifies a special character (special content). This identification information may include, for example, character IDs of some of the characters (special characters) included in the lottery target character group of a lottery game. Examples of special characters include a character whose rarity is at least a specific value (such as 6), a pickup character, a featured character that is featured in a lottery game, or the like.

Also, in the third embodiment, the quest information 50D includes identification information that identifies a special character (special content). This identification information may include, for example, character IDs of some of the characters (special characters) included in a quest clearance reward of a quest. Examples of this special character include a character whose rarity is at least a specific value (such as 5), a boss character, or the like.

Also, in the third embodiment, in response to a display request to display a list screen showing game types registered as a favorite, the control unit 54 preferentially displays on a list screen, from among the registered game types, those game types that satisfy a specific condition related to content not possessed by the player. For example, this may be content having a rarity of at least a specific value (such as 5).

Also, in the third embodiment, the specific condition may be that content not possessed by the player can be acquired. That is, in response to a display request, the control unit 54 preferentially displays on the list screen, from among the game types registered as a favorite, those game types for which content not possessed by the player can be acquired. For example, the control unit 54 refers to the possessed character information in the player information 50A, and extracts any characters that the player does not possess. Next, the control unit 54 refers to the lottery target information in the lottery game information 50C, or the clearance reward information in the quest information 50D, and identifies lottery games or quests in which characters not possessed by the player can be acquired.

Also, in the third embodiment, the specific condition may be that content that the player has never acquired can be acquired. That is, in response to a display request, the control unit 54 preferentially displays on the list screen, from among the game types registered as a favorite, those game types for which content that the player has never acquired can be acquired. For example, the control unit 54 refers to the acquired characters of the possessed content information in the player information 50A, and extracts characters that the player has never acquired in the past. Next, the control unit 54 refers to the lottery target information in the lottery game information 50C, or the clearance reward information in the quest information 50D, and identifies lottery games or quests in which the extracted characters can be acquired.

Also, in the third embodiment, if the player has acquired all the acquirable content in a game type that has already been registered as a favorite, the control unit 54 treats that game type as a game type to be canceled and proposes the cancelation of the registration of that game type to be canceled.

For example, the control unit 54 refers to the possessed character information and game type information in the player information 50A, as well as to the lottery target information in the lottery game information 50C, and, if the player has acquired all the characters included in the lottery target information, treats that lottery game as a lottery game to be canceled, from among the one or more lottery games registered as a favorite by the player, and proposes the cancelation of the registration of that lottery game to be canceled.

Also, for example, the control unit 54 refers to the possessed character information and game type information in the player information 50A, as well as to the clearance reward information in the quest information 50D, and, if the player has acquired all the characters included in the quest reward information, treats that quest as a quest to be canceled, from among the one or more quests registered as a favorite by the player, and proposes the cancelation of the registration of that quest to be canceled.

Also, in the third embodiment, if special content can be acquired in a game type that has already been registered as a favorite and a specific parameter of that special content possessed by the player has reached a certain value (such as 20), the control unit 54 treats that game type as a game type to be canceled and proposes the cancelation of the registration of that game type to be canceled.

For example, the control unit 54 refers to the possessed character information and game type information in the player information 50A, as well as to the lottery target information and identification information in the lottery game information 50C, and, if some or all of the special characters (such as characters with a rarity of 6) in a lottery game that the player has registered as a favorite are possessed by the player and a specific parameter of those special characters has reached a certain value (such as 20), treats that lottery game as a lottery game to be canceled and proposes the cancelation of the registration of that lottery game to be canceled.

Also, for example, the control unit 54 refers to the possessed character information and game type information in the player information 50A, as well as to the clearance reward information and identification information in the quest information 50D, and, if some or all of the special characters (such as boss characters) in a quest that the player has registered as a favorite are possessed by the player and a specific parameter of those special characters has reached a certain value (such as 99), treats that quest as a quest to be canceled and proposes the cancelation of the registration of that quest to be canceled.

Also, in the third embodiment, if the player has acquired all the acquirable content in a game type that has already been registered as a favorite, the control unit 54 treats that game type as a game type to be canceled and automatically cancels the registration of that game type to be canceled.

For example, the control unit 54 refers to the possessed character information and game type information in the player information 50A, as well as to the lottery target information in the lottery game information 50C, and, if the player has acquired all the characters included in the lottery target information, treats that lottery game as a lottery game to be canceled, from among the one or more lottery games registered as a favorite by the player, and automatically cancels the registration of that lottery game to be canceled.

Also, for example, the control unit 54 refers to the possessed character information and game type information in the player information 50A, as well as to the clearance reward information in the quest information 50D, and, if the player has acquired all the characters included in the quest reward information, treats that quest as a quest to be canceled, from among the one or more quests registered as a favorite by the player, and automatically cancels the registration of that quest to be canceled.

Also, in the third embodiment, if special content can be acquired in a game type that the player has already registered as a favorite and a specific parameter of that special content possessed by the player has reached a certain value, the control unit 54 treats that game type as a game type to be canceled and automatically cancels the registration of that game type to be canceled.

For example, the control unit 54 refers to the possessed character information and game type information in the player information 50A, as well as to the lottery target information in the lottery game information 50C, and, if the player possesses a special character (such as a character with a rarity of 6) in one or more lottery games that the player has registered as a favorite, and the specific parameter of that special character has reached a certain value (such as 10), treats that lottery game as a lottery game to be canceled and automatically cancels the registration of that lottery game to be canceled.

Also, for example, the control unit 54 refers to the possessed character information and game type information in the player information 50A, as well as to the clearance reward information in the quest information 50D, and, if one or more special characters in a quest that the player has registered as a favorite are possessed by the player and a specific parameter of those special characters has reached a certain value (such as 99), treats that quest as a quest to be canceled and automatically cancels the registration of that quest to be canceled.

Processing for Executing Favorite Game Type

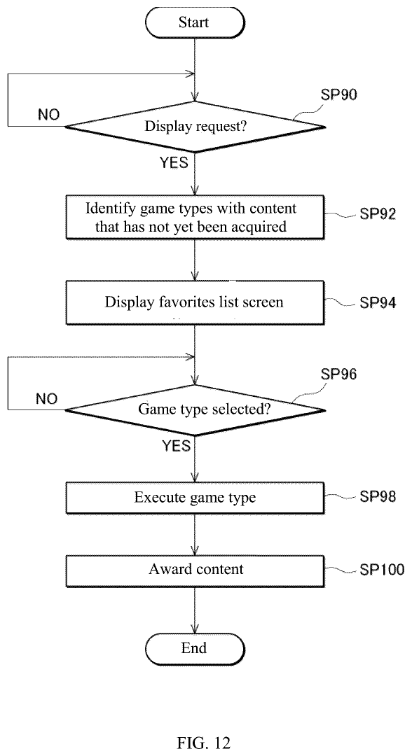

FIG. 12 is a flowchart showing an example of the flow of processing for executing a game type registered as a favorite in the game system according to the third embodiment. Also, the processing in the following steps is commenced at the time when the menu screen is displayed, for example. The order and details of the following steps can be changed as needed.

(Step SP90)

The reception unit 52 determines whether or not the player has pressed the favorites button on the menu screen. If the determination is positive, the processing then moves to the processing of step SP92. On the other hand, if the determination is negative, the processing moves to the processing of step S90.

(Step SP92)

The control unit 54 refers to the game type information in the player information 50A and extracts game types registered as a favorite. Then, the control unit 54 refers to the acquired characters in the possessed content information in the player information 50A, and extracts those characters whose rarity is at least a specific value (such as 6) which the player has never acquired in the past. Next, the control unit 54 refers to the lottery target information in the lottery game information 50C, or the clearance reward information in the quest information 50D, and identifies lottery games or quests in which the extracted characters can be acquired. Then, the processing moves to the processing of step S94.

(Steps SP94 to SP100)

The processing from step SP94 to step SP100 is the same as the processing from step SP14 to step SP20 described above, and therefore will not be described again. Then, the processing ends the processing series shown in FIG. 12.

Processing for Updating Favorite Game Types

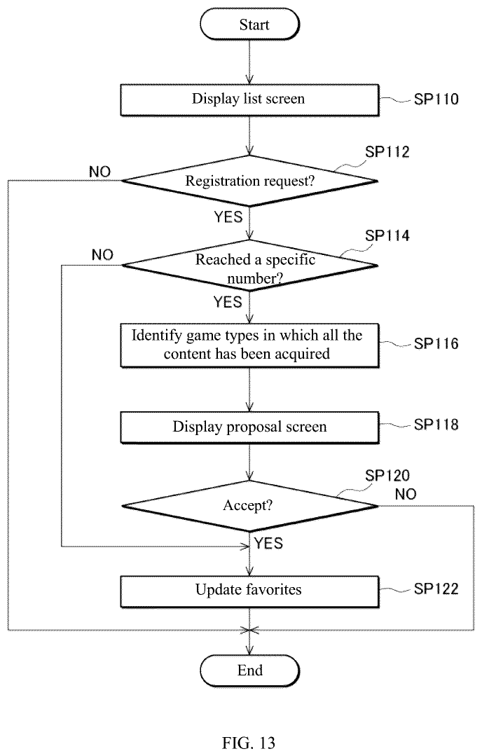

FIG. 13 is a flowchart showing an example of the flow of processing in updating the game types registered as a favorite in the game system according to the third embodiment. Also, the processing in the following steps is commenced, for example, at the time when an instruction to display a list of game types recently played by the player has been issued. The order and details of the following steps can be changed as needed.

(Steps SP110 to SP114)

The processing from step SP110 to step SP114 is the same as the processing from step SP30 to step SP34 described above, and therefore will not be described again. If the determination in step SP114 is positive, the processing moves on to the processing of step SP116. On the other hand, if the determination is negative, the processing moves to the processing of step SP122.

(Step SP116)

The control unit 54 refers to the game type information in the player information 50A and extracts game types registered as a favorite. Next, the control unit 54 refers to the acquired characters in the player information 50A, the lottery target information in the lottery game information 50C, and the clearance reward information in the quest information 50D, and identifies, from among the game types registered as a favorite, those game types in which the player has acquired all the content. Then, the processing moves to the processing of step SP118.

(Steps SP118 to SP122)

The processing from step SP118 to step SP122 is the same as the processing from step SP38 to step SP42 described above, and therefore will not be described again. Then, the processing ends the processing series shown in FIG. 13.

Effect

As described above, in the third embodiment, a computer is made to function as: the storage unit 50 for storing one or more game types registered as a favorite by the player; the reception unit 52 for receiving from the player a display request to display a list screen showing the registered game types; and the control unit 54 for preferentially displaying on the list screen, in response to the display request, those game types from among the registered game types that satisfy a specific condition related to content not possessed by the player.

With this configuration, game types that satisfy the specific condition related to content not possessed by the player are displayed preferentially on the list screen, which makes it easier to select game types that are registered as a favorite.

Also, in the third embodiment, the specific condition may be that content not possessed by the player can be acquired.

With this configuration, game types in which content that is not possessed by the player is acquirable are displayed preferentially on the list screen, which motivates the player to play those game types.

Also, in the third embodiment, the specific condition may be that content that the player has never acquired can be acquired.

With this configuration, game types in which content that the player has never acquired is acquirable are displayed preferentially on the list screen, which motivates the player to play those game types.

Also, in the third embodiment, the rarity of the content is at least a specific value.

With this configuration, game types in which very rare content that is not possessed by the player is acquirable are displayed preferentially on the list screen, which motivates the player to play those game types.

Also, in the third embodiment, if the player has acquired all the acquirable content in a game type that has already been registered as a favorite, the control unit 54 treats that game type as a game type to be canceled and proposes the cancelation of the registration of that game type to be canceled.

With this configuration, those game types in which the player has acquired all the acquirable content are treated as ones to be canceled, and their registration can be easily canceled, so the number of game types registered as a favorite can be controlled.

Also, in the third embodiment, if special content can be acquired in a game type that the player has already registered as a favorite and a specific parameter of that special content possessed by the player has reached a certain value, the control unit 54 treats that game type as a game type to be canceled and proposes the cancelation of the registration of that game type to be canceled.

With this configuration, if a player possesses special content in which a specific parameter has reached a certain value, those game types in which this special content can be acquired are treated as ones to be canceled, and their registration can be easily canceled, so the number of game types registered as a favorite can be controlled.

Also, in the third embodiment, the reception unit 52 receives from the player a registration request to register a new game type as a favorite, and, in response to the registration request, the control unit 54 proposes the cancelation of the registration of a game type to be canceled, and proposes instead the registration of the new game type as a favorite.

With this configuration, when registering a new game type, the registration of a game type to be canceled can be easily canceled, so the number of game types registered as a favorite can be controlled.

Also, in the third embodiment, if the number of game types already registered as a favorite has reached a specific number, in response to a registration request, the control unit 54 proposes the cancelation of the registration of a game type to be canceled, and proposes instead the registration of the new game type as a favorite.

With this configuration, if the number of registered game types has reached a specific number, the registration of a game type to be canceled can be easily canceled, and a new game type can be registered instead, so the number of game types registered as a favorite can be controlled.

Also, in the third embodiment, if the player has acquired all the acquirable content in a game type that has already been registered as a favorite, the control unit 54 treats that game type as a game type to be canceled and automatically cancels the registration of that game type to be canceled.

With this configuration, those game types in which the player has acquired all the acquirable content are treated as ones to be canceled, and their registration can be automatically canceled, so the number of game types registered as a favorite can be controlled.

Also, in the third embodiment, if special content can be acquired in a game type that the player has already registered as a favorite and a specific parameter of that special content possessed by the player has reached a certain value, the control unit 54 treats that game type as a game type to be canceled and automatically cancels the registration of that game type to be canceled.

With this configuration, if a player possesses special content in which a specific parameter has reached a certain value, those game types in which this special content can be acquired are treated as ones to be canceled, and their registration can be automatically canceled, so the number of game types registered as a favorite can be controlled.

Also, in the third embodiment, the reception unit 52 receives from the player a registration request to register a new game type as a favorite, and, in response to the registration request, the control unit 54 automatically cancels the registration of a game type to be canceled, and instead registers the new game type as a favorite.

With this configuration, when registering a new game type, the registration of a game type to be canceled can be automatically canceled, so the number of game types registered as a favorite can be controlled.

Also, in the third embodiment, if the number of game types already registered as a favorite has reached a specific number, in response to a registration request, the control unit 54 automatically cancels the registration of a game type to be canceled, and instead registers the new game type as a favorite.

With this configuration, if the number of registered game types has reached a specific number, the registration of a game type to be canceled can be automatically canceled, and a new game type can be registered instead, so the number of game types registered as a favorite can be controlled.

Modifications

The present invention is not limited to or by the above specific examples. That is, suitable design changes made to the above specific examples by a person skilled in the art are also encompassed by the scope of the present invention as long as they still have the features of the present invention. Also, the elements of the embodiments described above and the modified examples (discussed below) can be combined to the extent that this is technically possible, and these combinations are also encompassed by the scope of the present invention as long as they still have the features of the present invention.

For example, in the first embodiment, an example was described in which the control unit 54 preferentially displays on the list screen those game types whose execution deadline had not yet arrived, but game types with an execution deadline may be displayed preferentially over game types that can be played at any time and have no execution deadline. On the other hand, the control unit 54 may preferentially display game types that have no execution deadline and can be played at any time over game types that have an execution deadline.

Also, in the first embodiment, an example was described in which the control unit 54 preferentially displays on the list screen game types for which the period from the time when a display request was made until the execution deadline of the game type was within a specific timeframe, but game types may be preferentially displayed starting with those having the shortest duration. On the other hand, the control unit 54 may preferentially display game types starting with those having the longest duration.

Also, in the second embodiment, an example was described in which the game type information in the player information 50A included the number of executions (how many times the player has played a game type) for each game type, but this number of executions may instead be the number of times that high rarity content (such as content with a rarity of 5 or more) has been acquired, or the number of times that a quest has been cleared.

Also, in the third embodiment, an example was described in which, if the player has acquired all the acquirable content in a game type, the control unit 54 treated that game type as a game type to be canceled, but if the player has acquired all the special content in a game type, that game type may be treated as a game type to be canceled. For example, the control unit 54 may refer to the identification information in the lottery game information 50C, and, if the player has acquired all the special characters in one or more lottery games registered as a favorite by the player, that lottery game may be treated as a lottery game to be canceled. Also, for example, the control unit 54 may refer to the identification information, etc., in the quest information 50D, and, if the player has acquired all the special characters in one or more quests registered as a favorite by the player, that quest may be treated as a quest to be canceled.

Also, in the first embodiment, the second embodiment, and the third embodiment, an example was given in which, if the number of game types already registered as a favorite has reached a specific number, the control unit 54 proposes the cancelation of the registration of a game type to be canceled, etc., but the specific number may be a different number for each player. For example, the specific number may vary depending on the player rank or a number preset by the player.

Also, in the first embodiment, the second embodiment, and the third embodiment, characters were mainly used as an example of content, but various items (weapons, armor, jewels, etc.), cards, avatars, coins, points, etc., may also be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10: server device, 12: terminal device, 50: storage unit, 52: reception unit, 54: control unit

What is claimed is:

1. A non-transitory computer readable recording medium storing instructions for an information processing device that comprises a processor, a storage device, and a display device, the instructions causing the processor to execute:
storing, in the storage device, one or more game types that have been registered as a favorite by a player;
receiving, from the player via a terminal device, a display request to display a list screen showing the registered game types; and
in response to the display request, preferentially displaying on the list screen in the display device, from among the registered game types, a game type that satisfies a specific condition related to an execution deadline indicating an end of the game type.

2. The non-transitory computer readable recording medium according to claim 1, wherein
the specific condition is that the execution deadline has not yet arrived at a time of receiving the display request.

3. The non-transitory computer readable recording medium according to claim 1, wherein
the specific condition is that a time period from a time of receiving the display request until the execution deadline is within a specific time period.

4. The non-transitory computer readable recording medium according to claim 1, wherein
in a case where the execution deadline has arrived for a specific game type among the game types already registered as the favorite, the processor proposes to cancel registration of the specific game type.

5. The non-transitory computer readable recording medium according to claim 4, wherein the processor:
receives, from the player via the terminal device, a registration request to register a new game type as a favorite, and
in response to the registration request, proposes to cancel the registration of the specific game type, and instead proposes to register the new game type as the favorite.

6. The non-transitory computer readable recording medium according to claim 1, wherein
in a case where the execution deadline has arrived for a specific game type among the game types already registered as the favorite, the processor automatically cancels registration of the specific game type.

7. A non-transitory computer readable recording medium storing instructions for an information processing device that comprises a processor, a storage device, and a display device, the instructions causing the processor to execute:
storing, in the storage device, one or more game types that have been registered as a favorite by a player;
receiving, from the player via a terminal device, a display request to display a list screen showing the registered game types; and
in response to the display request, preferentially displaying on the list screen in the display device, from among the registered game types, a game type that satisfies a specific condition related to a number of game executions by the player.

8. The non-transitory computer readable recording medium according to claim 7, wherein
the specific condition is that the number of game executions is at least a first specific number of times.

9. The non-transitory computer readable recording medium according to claim 7, wherein
the specific condition is that the number of game executions is less than a first specific number of times.

10. The non-transitory computer readable recording medium according to claim 7, wherein
the specific condition is that the number of game executions within a time period from a time of receiving the display request until a specific time period ago is at least a first specific number of times.

11. The non-transitory computer readable recording medium according to claim 8, wherein
in a case where the number of game executions is less than a second specific number of times that is less than a first specific number of times for a specific game type among the game types already registered as the favorite, the processor proposes to cancel registration of the specific game type.

12. The non-transitory computer readable recording medium according to claim 9, wherein
in a case where the number of game executions is equal to or larger than a second specific number of times that is larger than a first specific number of times for a specific game type among the game types already registered as the favorite, the processor proposes to cancel registration of the specific game type.

13. The non-transitory computer readable recording medium according to claim 10, wherein
in a case where the number of game executions during the time period is less than a second specific number of times that is less than a first specific number of times for a specific game type among the game types already registered as the favorite, the processor proposes to cancel registration of the specific game type.

14. The non-transitory computer readable recording medium according to claim 11, wherein the processor
receives, from the player via the terminal device, a registration request to register a new game type as a favorite, and
in response to the registration request, proposes to cancel the registration of the specific game type.

15. The non-transitory computer readable recording medium according to claim 5, wherein
in a case where a number of game types already registered as the favorite has reached a specific number, in response to the registration request, the processor proposes to cancel the registration of the specific game type, and instead proposes to register the new game type as the favorite.

16. The non-transitory computer readable recording medium according to claim 10, wherein
in a case where the number of game executions during the time period is less than a second specific number of times that is less than a first specific number of times for a specific game type among the game types already registered as the favorite, the processor automatically cancels registration of the specific game type.

17. The non-transitory computer readable recording medium according to claim 6, wherein the processor:
receives, from the player via the terminal device, a registration request to register a new game type as a favorite, and
in response to the registration request, automatically cancels the registration of the specific game type, and instead registers the new game type as the favorite.

18. The non-transitory computer readable recording medium according to claim 17, wherein the processor:
receives, from the player via the terminal device, a registration request to register a new game type as a favorite, and,
in a case where a number of game types already registered as the favorite has reached a specific number, in response to the registration request, the processor automatically cancels the registration of the specific game type, and instead registers the new game type as the favorite.

19. An information processing device, comprising:
a storage device;
a display device; and
a processor that:
stores, in the storage device, one or more game types that have been registered as a favorite by a player;
receives, from the player via a terminal device, a display request to display a list screen showing the registered game types; and
in response to the display request, preferentially displays on the list screen in the display device, from among the registered game types, a game type that satisfies a specific condition related to an execution deadline indicating an end of the game type.

20. An information processing device, comprising:
a storage device;
a display device; and
a processor that:
stores, in the storage device, one or more game types that have been registered as a favorite by a player;
receives, from the player via a terminal device, a display request to display a list screen showing the registered game types; and
in response to the display request, preferentially displays on the list screen in the display device, from among the registered game types, a game type that satisfies a specific condition related to a number of game executions by the player.

21. The information processing device according to claim 20, wherein
the specific condition is that the number of game executions is at least a first specific number of times.

22. The information processing device according to claim 20, wherein
the specific condition is that the number of game executions is less than a first specific number of times.

23. The information processing device according to claim 20, wherein
the specific condition is that the number of game executions within a time period from a time of receiving the display request until a specific time period ago is at least a first specific number of times.
